(19) United States
(12) Patent Application Publication
(10) Pub. No.: US 2026/0211721 A1
(43) Pub. Date: Jul. 23, 2026

(54) JOB EXECUTION MANAGEMENT SYSTEM AND JOB EXECUTION MANAGEMENT METHOD

(71) Applicant: Hitachi Vantara, Ltd., Yokohama-shi (JP)

(72) Inventors: Shimpei NOMURA, Tokyo (JP); Mitsuo HAYASAKA, Tokyo (JP)

(21) Appl. No.: 19/329,743

(22) Filed: Sep. 16, 2025

(30) Foreign Application Priority Data
Jan. 20, 2025 (JP) 2025-007736

(51) Int. Cl. G06F 9/48

(52) U.S. Cl. CPC G06F 9/4875

(57) ABSTRACT

An object of the present invention is to efficiently use compute resources at the time of executing a job. A cloud management system for managing execution of a job in a computer system configured by a plurality of sites, has a memory and a CPU. The memory stores data specifying information which can specify data used in the job. The CPU is configured to determine start time of each process so that at least a part of a data migrating process of migrating data used in a job specified by the data specifying information to a site where the job is executed and a part of an environment creating process of creating a compute environment for executing the job in the site where the job is executed can be executed in parallel.

### CROSS-REFERENCE TO RELATED APPLICATION

The present application claims priority from Japanese application JP2025-007736, filed on Jan. 20, 2025, the content of which is hereby incorporated by reference into this application.

### BACKGROUND

The present disclosure relates to a technique of managing execution of a job in a computer system configured by a plurality of sites.

In the generative AI (Artificial Intelligence), it is necessary to utilize the cloud having abundance of high-performance compute resources such as a GPU (Graphics Processing Unit). There is, for example, a file virtualization function which enables data to be shared among a plurality of sites like between an on-premise site and the cloud. By the file virtualization function, data can be utilized without awareness of data placement among sites.

To improve the performance in an entire computer system and to realize lower cost, it is necessary to effectively use the compute resources such as a GPU without wasting them.

For example, U.S. Pat. No. 10,084,877 discloses a technique of prefetching data among sites. In the technique of U.S. Pat. No. 10,084,877, at the time of accessing data, on the basis of data access logs in the past, data expected to be accessed next is predicted and prefetched. It can reduce data transfer wait time accompanying a data access to another site.

### SUMMARY

For example, in the technique of U.S. Pat. No. 10,084,877, data transfer and prefetch starts at the time of accessing data of a job. Consequently, data migration wait time occurs since the data access starts after creation of a GPU instance in the cloud until data necessary to start a process of the job is collected. As a result, a state where the expensive GPU instance is held in vain occurs, and the cost increases.

In consideration of the above-described circumstances, an object of the present invention is to provide a technique which enables compute resources to be efficiently used.

In order to achieve the above object, a job execution management system according to one aspect is a job execution management system for managing execution of a job in a computer system configured by a plurality of sites, and includes a storage unit and a processor. The storage unit stores data specifying information which can specify data used in the job, and the processor determines start time of each process so that at least a part of a data migrating process of migrating data used in a job specified by the data specifying information to a site where the job is executed, and a part of an environment creating process of creating a compute environment for executing the job in the site where the job is executed can be executed in parallel.

According to the present invention, it is possible to efficiently use compute resources.

### BRIEF DESCRIPTION OF THE DRAWINGS

FIG. 1 is a general configuration diagram of a computer system according to a first embodiment.

FIG. 2 is a configuration diagram of a hybrid cloud management system according to the first embodiment.

FIG. 3 is a configuration diagram of a system of a site according to the first embodiment.

FIG. 4 is a diagram illustrating an example of a file configuration of a file system managed by a plurality of sites according to the first embodiment.

FIG. 5 is a configuration diagram of file virtualization management information according to the first embodiment.

FIG. 6 is a configuration diagram of a compute environment creation management table according to the first embodiment.

FIG. 7 is a configuration diagram of a job information management table according to the first embodiment.

FIG. 8 is a flowchart of a job analyzing process according to the first embodiment.

FIG. 9 is a flowchart of a schedule executing process according to the first embodiment.

FIG. 10 is a diagram for explaining a schedule of a series of processes related to execution of a job according to the first embodiment.

FIG. 11 is a configuration diagram of a compute environment creation management table according to a second embodiment.

FIG. 12 is a configuration diagram of a job information management table according to the second embodiment.

FIG. 13 is a flowchart of a job analyzing process according to the second embodiment.

FIG. 14 is a flowchart of a schedule executing process according to the second embodiment.

FIG. 15 is a diagram for explaining a first schedule of a series of processes related to execution of a job according to the second embodiment.

FIG. 16 is a diagram for explaining a second schedule of a series of processes related to execution of the job according to the second embodiment.

### DETAILED DESCRIPTION

Preferred embodiments will be described in accordance with the accompanying drawings. The embodiments which will be described hereinafter do not limit the invention in the scope of claims for a patent, and all of elements and combinations of the elements described in the embodiments are not always necessary to the solving means of the invention.

Although information may be described by an expression “AAA table” in the following description, information may be expressed in any data structure. That is, to express that information does not depend on a data structure, “AAA table” can be called “AAA information”.

In the following description, there is a case where processes will be described using a “program” as an operation main body. By being executed by a processor, a program performs a predetermined process while properly using at least one of a storage device and an interface. Consequently, the main body of the process may be also described as a processor (alternatively, a computer or a computer system having the processor). A program may be installed from a program source to a computer. A program source may be, for example, a recording medium which can be read by a program distribution server or a computer (for example, a portable recording medium). In the following description, two or more programs may be realized as one program. One program may be realized as two or more programs. At least a part of processes realized when a program is executed may be realized by a hardware circuit (for example, an ASIC (Application Specific Integrated Circuit) or an FPGA (Field-Programmable Gate Array)).

### First Embodiment

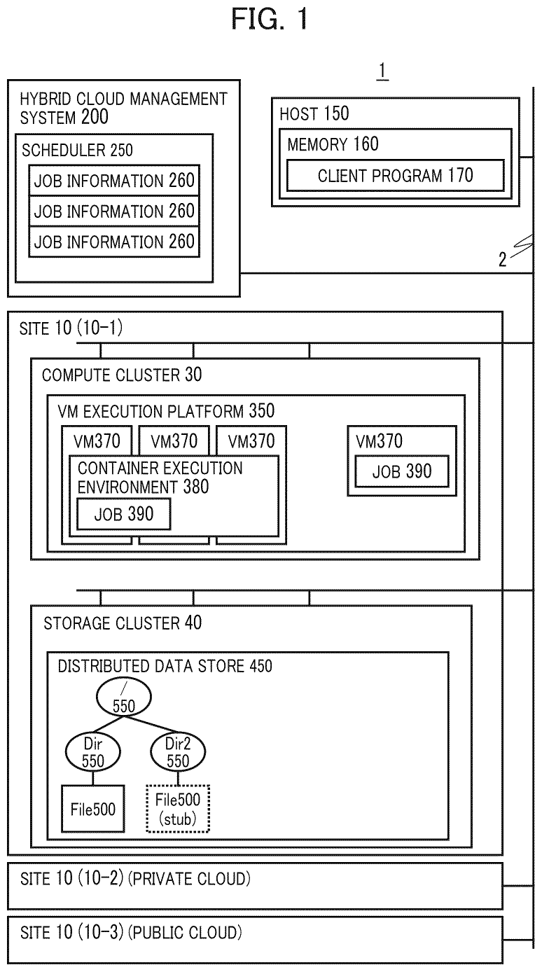

FIG. 1 is a general configuration diagram of a computer system according to a first embodiment.

A computer system 1 includes a host 150, a hybrid cloud management system 200, and a plurality of sites 10 (10-1, 10-2, 10-3). The host 150, the hybrid cloud management system 200, and the plurality of sites 10 (10-1, 10-2, 10-3) are connected so as to be able to communicate with one another, for example, via a WAN (Wide Area Network) 2 as an example of the network.

The host 150 is, for example, a computer such as a PC (Personal Computer) and is used by the user of the computer system 1. The host 150 has a memory 160. The memory 160 stores a client program 170. When the client program 170 is executed by a not-illustrated processor of the host 150, for example, it performs a process of receiving a request of executing a job 390 from the user and transmitting it to the hybrid cloud management system 200.

The hybrid cloud management system 200 has a scheduler 250 for scheduling the job 390 of processing data. The scheduler 250 executes scheduling of processes related to a job, migration of data used by the job 390, a predetermined process related to data, and the like. The scheduler 250 stores job information 260 as information related to a job. In the embodiment, the job 390 is executed on a container or a VM (Virtual Machine) in any of the sites 10 (10-1, 10-2, 10-3, and the like). The job 390 may be executed, for example, on a bare metal node. Although the hybrid cloud management system 200 is a component different from the site 10 in the example of FIG. 1, it may be configured in any of the sites 10.

The site 10 (10-1, 10-2, 10-3, and the like) stores data used by a job, builds a container, and executes a process related to a job and data. The sites 10 are mounted, for example, in places which are apart geographically and may be mounted across countries. In the example of FIG. 1, the computer system 1 has the three sites 10-1 to 10-3. The number of sites 10 is not limited to the above but may be any plural number. In the example of FIG. 1, the site 10-1 is on a premise, the site 10-2 is in a private cloud, and the site 10-3 is in the public cloud. It is just an example. The kinds of the sites 10 are not limited to the example.

The site 10 includes a compute cluster 30 performing calculating process and a storage cluster 40 storing data. In the compute cluster 30, a VM execution platform 350 is built. On the VM execution platform 350, a plurality of VMs 370 are built. The job 390 is executed on the VM 370 or a container in a container execution environment 380 constructed by a plurality of VMs 370. In the storage cluster 40, a distributed data store 450 is built. The distributed data store 450 manages a file system. The file system manages a directory 550 and a file 500.

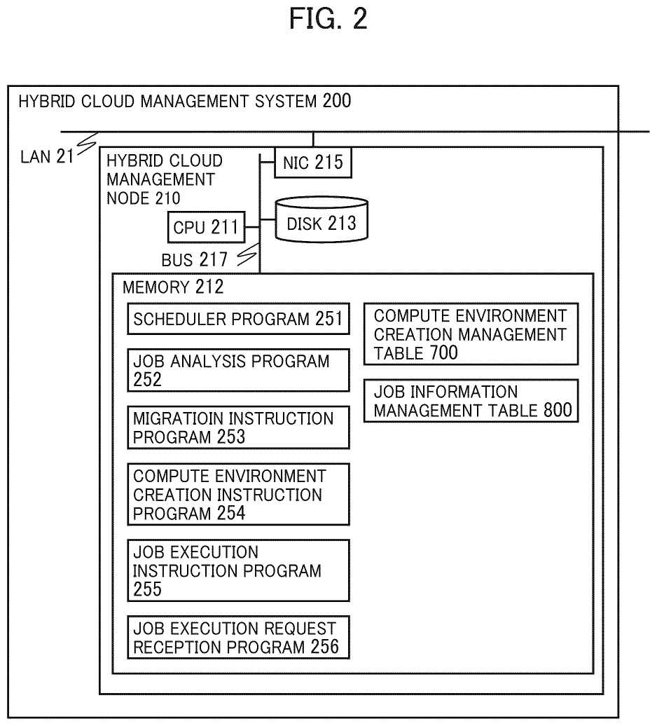

FIG. 2 is a configuration diagram of a hybrid cloud management system according to the first embodiment.

The hybrid cloud management system 200 has, for example, a hybrid cloud management node 210 and a LAN (Local Area Network) 21. The LAN 21 is connected to the WAN 2.

The hybrid cloud management node 210 is an example of the job execution management system, and is a computer node performing a process of managing execution of a job. The hybrid cloud management node 210 is configured by a general computer in the embodiment but may be configured by a dedicated device. The hybrid cloud management system 100 is realized by a single computer in the embodiment. It may be realized by a cluster obtained by linking a plurality of computers or realized by a VM.

The hybrid cloud management node 210 has a CPU (Central Processing Unit) 211 as an example of a processor, a memory 212, a disk 213, and an NIC (Network Interface Card) 215. The CPU 211, the memory 212, the disk 213, and the NIC 215 are connected so as to be able to communicate with one another via a bus 217.

The CPU 211 performs various processes by reading a program recorded in the memory 212 and executing the program. The memory 212 is, for example, a RAM (Random Access Memory) and stores a program which is executed by the CPU 211 and various information and the like used or generated by a program. The memory 212 is an example of a storage unit. The disk 213 is, for example, a secondary storage device such as a hard disk or flash memory, and stores a program executed by the CPU 211 and data used by the CPU 211. The disk 213 is an example of the storage unit. The NIC 215 is an interface for communicating with other devices via the LAN 21.

The memory 212 stores a scheduler program 251, a job analysis program 252, a migration instruction program 253, a compute environment creation instruction program 254, a job execution instruction program 255, and a job execution request reception program 256. The memory 212 stores, as management information, a compute environment creation management table 700 and a job information management table 800 as an example of data specifying information. The scheduler 250 is configured by executing, by the CPU 211, the scheduler program 251, the job analysis program 252, the migration instruction program 253, the compute environment creation instruction program 254, the job execution instruction program 255, and the job execution request reception program 256.

By being executed by the CPU 211, the scheduler program 251 manages the job 390 for which an execution request is received from the host 150, and determines an execution schedule. By being executed by the CPU 211, the job analysis program 252 analyzes the job 390 and specifies data which is accessed by the job 390. By being executed by the CPU 211, the migration instruction program 253 instructs a data migration to the storage cluster 40 of each site 10. By being executed by the CPU 211, the compute environment creation instruction program 254 instructs the compute cluster 30 to create a compute environment. By being executed by the CPU 211, the job execution instruction program 255 instructs the compute cluster 30 to execute the job 390. By being executed by the CPU 211, the job execution request reception program 256 receives a request to execute the job 390 from the host 150.

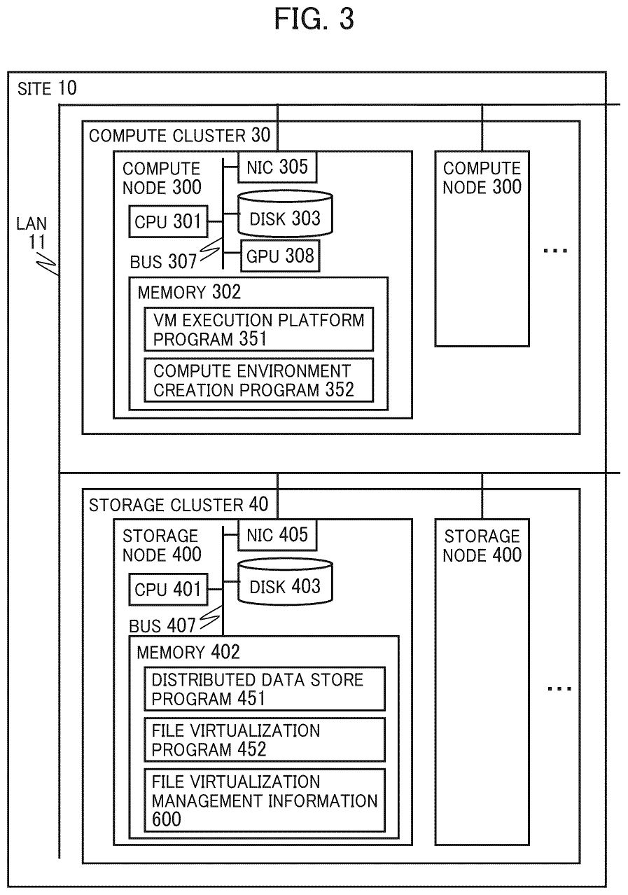

FIG. 3 is a configuration diagram of a system of a site according to the first embodiment.

The site 10 (10-1, 10-2, 10-3, and so on) has one or more compute clusters 30 and one or more storage clusters 40 as an infrastructure for storing data and executing a predetermined process. The compute cluster 30 and the storage cluster 40 are connected so as to be able to communicate with each other via a LAN 11. The LAN 11 is connected to the WAN 2.

The compute cluster 30 includes one or more compute nodes 300. The compute nodes 300 constructing the compute cluster 30 may have equivalent configurations or different configurations.

The compute node 300 is a computer node executing a job and performing a predetermined process. Although the compute node 300 is configured by a general computer in the embodiment, it may be configured by a dedicated device.

The compute node 300 has a CPU 301, a memory 302, a disk 303, an NIC 305, and a GPU (Graphics Processing Unit) 308. The CPU 301, the memory 302, the disk 303, the NIC 305, and the GPU 308 are connected so as to be able to communicate with one another via a bus 307.

The CPU 301 performs various processes by reading a program recorded in the memory 302 and executing the program. The memory 302 is, for example, a RAM and stores a program executed by the CPU 301 and various information and the like used or generated by the program. The disk 303 is, for example, a secondary storage device such as a hard disk or flash memory and stores a program executed by the CPU 301 and data used by the CPU 301. The NIC 305 is an interface for communicating with other devices via the LAN 11. The GPU 308 performs various processes by executing a program.

The memory 302 stores a VM execution platform program 351 and a compute environment creation program 352. By being executed by the CPU 301, the VM execution platform program 351 assures a VM for executing the job 390, allocates hardware resources, and obtains metrics of hardware and an execution log. The compute environment creation program 352 creates an environment (compute environment) for executing a job on a VM. When an instruction of compute environment creation is received from the compute environment creation instruction program 254, the VM execution platform program 351 ensures a VM for executing the job 390, and the compute environment creation program 352 creates an environment (compute environment) for executing a job on the ensured VM.

The storage cluster 40 includes one or more storage nodes 400. The storage nodes 400 constructing the storage cluster 40 may have equivalent configurations or different configurations.

The storage node 400 is a computer node executing a data storing process and managing data. The storage node 400 is configured by a general computer in the embodiment but may be configured by a dedicated device.

The storage node 400 has a CPU 401, a memory 402, a disk 403, and an NIC 405. The CPU 401, the memory 402, the disk 403, and the NIC 405 are connected so as to be able to communicate with one another via a bus 407.

The CPU 401 performs various processes by reading a program recorded in the memory 402 and executing the program. The memory 402 is, for example, a RAM and stores a program executed by the CPU 401 and various information and the like used or generated by the program. The disk 403 is, for example, a secondary storage device such as a hard disk or a flash memory. The NIC 405 is an interface for communicating with other devices via the LAN 11.

The memory 402 stores a distributed data store program 451 and a file virtualization program 452. The memory 402 stores file virtualization management information 600 as management information. By being executed by the CPU 401, the distributed data store program 451 manages data to be stored and executes an IO request to data from the job 390. The distributed data store program 451, for example, manages data by a file system. By being executed by the CPU 401, the file virtualization program 452 performs a virtualizing process for making data in another site seen as if the data exists in its site.

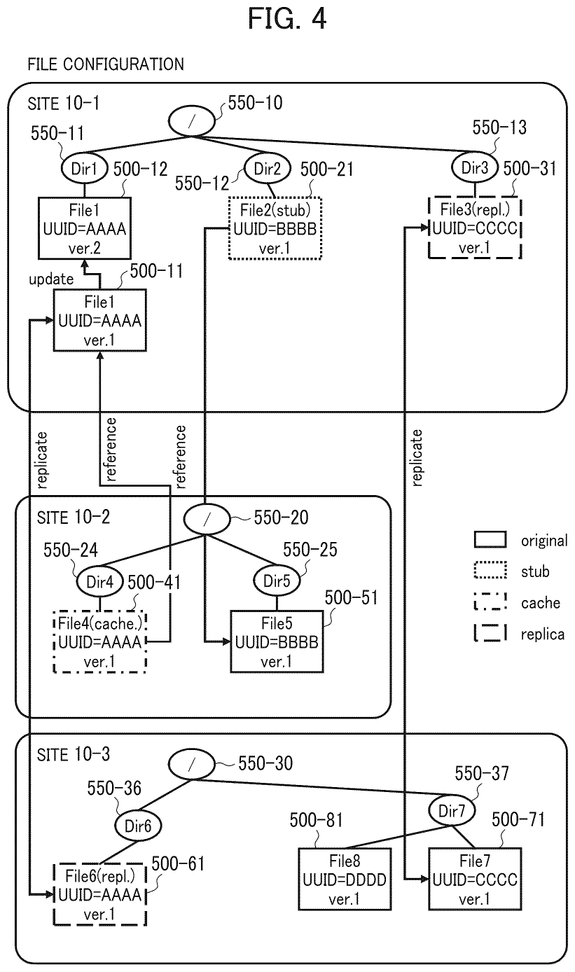

FIG. 4 is a diagram illustrating an example of the file configuration of a file system managed by a plurality of sites according to the first embodiment.

In the embodiment, the kinds of files in a file system are an original file (depicted as “original” in the diagram), a stub file (depicted as “stub” in the diagram), a cache file (depicted as “cache” in the diagram), and a replica file (depicted as “replica” in the diagram). A stub file, a cache file, and a replica file are generated by the file virtualization program 452.

An original file is a file including real data (original data) generated and managed in its site 10. A stub file is a file generated to refer to data of an original file in another site. A cache file is a file in which all of data in a file in a stub file is cached. A replica file is a file obtained by copying an original file in another site for the purpose of backup or the like. In the file system according to the embodiment, UUIDs (Universally Unique Identifiers) of a stub file, a cache file, and a replica file corresponding to a certain original file are the same as the UUID of the original file. Each of the files 500 (500-11, 500-12, and so one) can be specified by a unique UUID in a file system managed by the distributed data store programs 451 of the plurality of sites 10. In the embodiment, in each file, further, version management is performed. A file of a specific version can be specified by the UUID and the version number.

The file system managed by the distributed data store program 451 of the site 10-1 has a root directory 550-10 and directories 550-11, 550-12, and 550-13 as lower-level directories of the root directory 550-10.

In the directory 550-11, the files 500-11 and 500-12 are stored. The file 500-11 is an original file having file name “File 1”, UUID is “AAAA”, and version number is “ver. 1”. The file 500-12 is an updated file of the file 500-11, and the version number is updated to “ver. 2”. In the directory 550-12, a file 500-21 is stored. The file 500-21 is a stub file whose original file is a file 500-51 stored in the site 10-2. In the directory 550-13, a file 500-31 is stored. The file 500-31 is a replica file obtained by replicating a file 500-71 stored in the site 10-3.

A file system of the site 10-2 has a root directory 550-20 and directories 550-24 and 550-25 as lower-level directories of the root directory 550-20.

In the directory 550-24, a file 500-41 is stored. The file 500-41 is a cache file corresponding to the file 500-11 in the site 10-1. In the directory 550-25, the file 500-51 is stored. The file 500-51 is an original file, and the corresponding stub file 500-21 is stored in the site 10-1.

The file system of the site 10-3 has a root directory 550-30 and directories 550-36 and 550-37 as lower-level directories of the root directory.

In the directory 550-36, a file 500-61 is stored. The file 500-61 is a file obtained by replicating the file 500-11 of the site 10-1. In the directory 550-37, the file 500-71 and a file 500-81 are stored. The file 500-71 is an original file, and the file 500-31 obtained by replicating this file is stored in the site 10-1. The file 500-81 is an original file.

The detailed configuration of the file virtualization management information 600 will now be described.

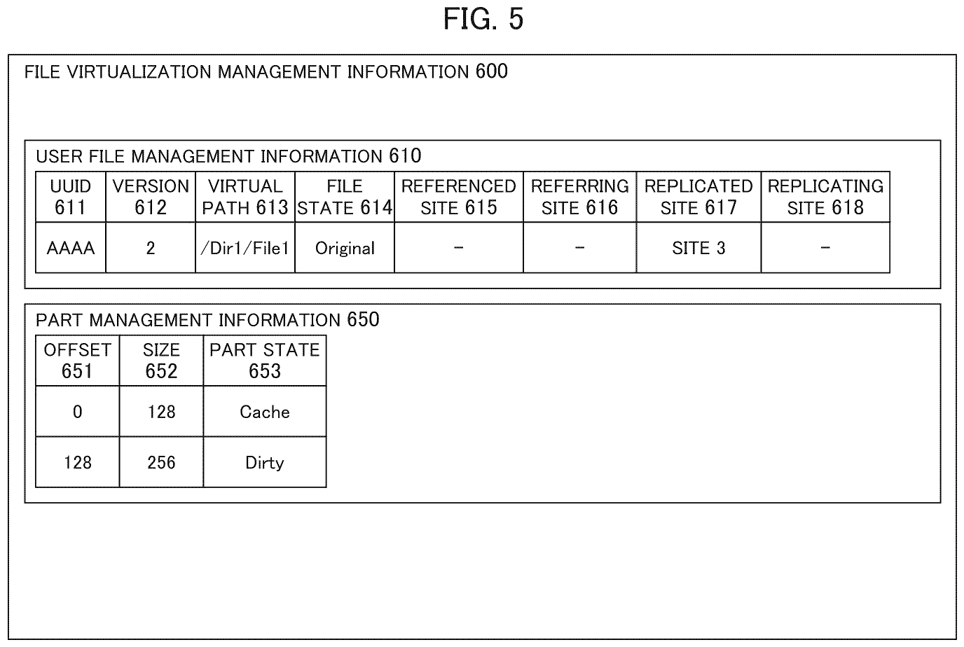

FIG. 5 is a configuration diagram of the file virtualization management information according to the first embodiment. The file virtualization management information 600 is generated for each user file 500. The file virtualization management information 600 of FIG. 5 is information corresponding to the file 500-12 in FIG. 4.

The file virtualization management information 600 includes user file management information 610 and part management information 650.

The user file management information 610 includes fields of UUID 611, version 612, virtual path 613, file state 614, referenced site 615, referring site 616, replicated site 617, and replicating site 618.

In the UUID 611, the UUID of the file 500 (in the description of FIG. 5, called the corresponding user file) corresponding to the file virtualization management information 600 is stored. In the version 612, the version number of the corresponding user file is stored. In the virtual path 613, a file path indicating the storage destination of the corresponding user file in the file system in the site is stored. In the file state 614, the kind of the corresponding user file is stored. The kinds of the corresponding user file include “original”, “stub”, “cache”, and “replica”.

In the referenced site 615, in the case where a corresponding user file is a stub file, the site name of a site (referenced site) in which the original file corresponding to the stub file is stored is stored. In the referring site 616, in the case where the corresponding user file is the original file, the site name of a site (referring site) in which a stub file corresponding to the original file is stored is stored. In the replicated site 617, the site name of a site (replicated site) in which a replica file of the corresponding user file is stored is stored. In the replicating site 618, in the case where the corresponding user file is a replica file, the site name of a site (replicating site) in which the original file corresponding to the replication file is stored is stored.

The part management information 650 includes an entry corresponding to each of parts of a corresponding user file. An entry of the part management information 650 includes fields of offset 651, size 652, and part state 653.

In the offset 651, an offset value indicating the head position in the corresponding user file of the part corresponding to the entry is stored. In the size 652, the data size of the part corresponding to the entry is stored. In the part state 653, the state of the part corresponding to the entry is stored. The state of the part is “Cache”, “Dirty”, or “Stub”. “Cache” indicates that there is real data of the part corresponding to the entry, and the real data is already replicated to the replicated site. “Dirty” indicates that there is real data of the part corresponding to the entry but the real data is not replicated in the replicated site. “Stub” indicates that there is no real data of the part corresponding to the entry. When the state of the part is “Stub”, it means that when there is an access request to this part, real data of this part has to be obtained (recalled) from another site.

The detailed configuration of the compute environment creation management table 700 will now be described.

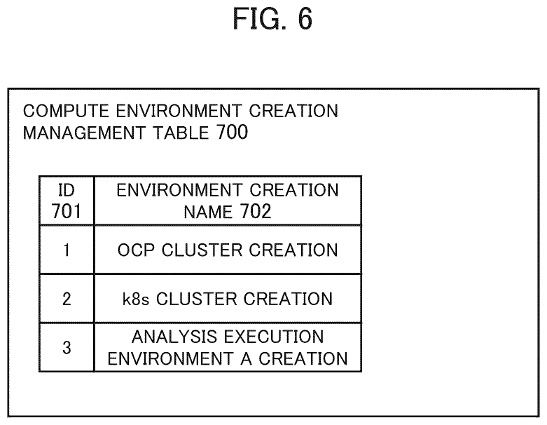

FIG. 6 is a configuration diagram of a compute environment creation management table according to the first embodiment.

The compute environment creation management table 700 includes an entry for each compute environment creation which can be created by the compute cluster 30. An entry of the compute environment creation management table 700 includes fields of ID 701 and environment creation name 702. In the ID 701, the identifier of compute environment creation corresponding to the entry is stored. In the environment creation name 702, the name of compute environment creation corresponding to the entry is stored.

The detailed configuration of the job information management table 800 will now be described.

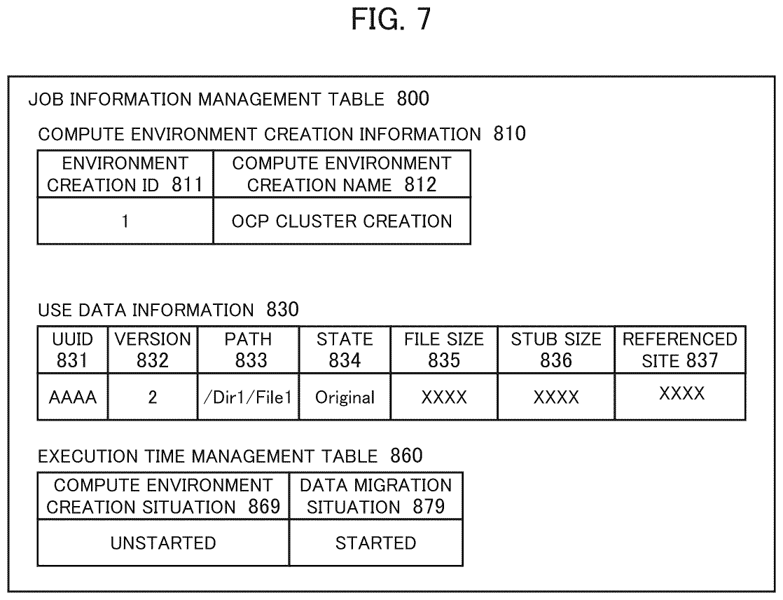

FIG. 7 is a configuration diagram of a job information management table according to the first embodiment.

The job information management table 800 is generated for each job 390. The job information management table 800 includes compute environment creation information 810, a use data information 830, and an execution time management table 860.

As the compute environment creation information 810, information of compute environment creation (corresponding compute environment creation) for executing a job (which will be called a corresponding job) to which the job information management table 800 corresponds is stored. The compute environment creation information 810 includes fields of environment creation ID 811 and compute environment creation name 812. In the environment creation ID 811, the identifier of corresponding compute environment creation is stored. The identifier corresponds to the identifier of the ID 701 in the compute environment creation management table 700. In the compute environment creation name 812, the name of the corresponding compute environment creation is stored.

In the use data information 830, information for accessing a file (use file) used by the corresponding job is stored. The use data information 830 includes an entry for each use file. An entry of the use data information 830 includes fields of UUID 831, version 832, path 833, state 834, file size 835, stub size 836, and referenced site 837.

In the UUID 831, the UUID of a use file corresponding to an entry is stored. In the version 832, the version number of the use file corresponding to the entry is stored. In the path 833, a file path indicating the storage destination in a file system in a site of the use file corresponding to the entry is stored. In the state 834, the state of the use file corresponding to the entry is stored. In the file size 835, the data size of the use file corresponding to the entry is stored. In the stub size 836, in the case where the use file corresponding to the entry is a stub file, the data size of the total of a part which is a stub in which real data does not exist is stored. In the referenced site 837, in the case where the use file corresponding to the entry is a stub file, the site name of a site (referenced site) in which the original file corresponding to the use file is stored is stored.

In the execution time management table 860, information for managing an execution state of a process related to a corresponding job is stored. The execution time management table 860 includes fields of compute environment creation situation 869 and data migration situation 879. In the compute environment creation situation 869, the situation of the compute environment creation executing a corresponding job is stored. The situation includes “unstarted” indicating that creation is not started, “started” indicating that creation started, and “completed” indicating that creation is completed. In the data migration situation 879, the situation of migration of data used in the corresponding job is stored. The situation includes “unstarted” indicating that migration of data is not started, “started” indicating that migration of data started, and “completed” indicating that migration of data is completed.

The process operations of the computer system 1 will now be described.

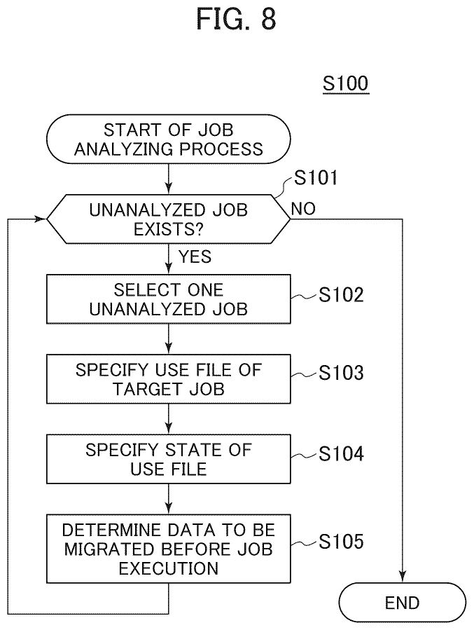

FIG. 8 is a flowchart of a job analyzing process according to the first embodiment.

A job analyzing process (S100) is executed, for example, in such a case where the job execution request receiption program 256 of the hybrid cloud management node 210 receives a job execution request via a client process by the client program 170 of the host 150.

In the job analyzing process, use data in each job and the content of compute environment creation for executing the job are recognized, and data migration of data used in the job, the compute environment creation, and a job execution timing are scheduled. In the example of FIG. 8, as the data migration to be scheduled, data migration of migrating data which is used in the job and of a file in a stub state by file virtualization is a target. Alternatively, for example, in data hierarchy control or the like, data migration of migrating data to be used in a job, which is placed in a remote site or a low-performance storage device before job execution to a local site or a high-performance storage device may be set as a target.

In the job analyzing process, first, the job analysis program 252 (strictly, the CPU 211 which executes the job analysis program 252) checks whether an unanalyzed job exists or not (S101). In the case where there is no unanalyzed job as a result of the check (NO in S101), the job analysis program 252 finishes the job analyzing process.

On the other hand, in the case where there is an unanalyzed job (YES in S101), the job analysis program 252 selects one of unanalyzed jobs as a job to be analyzed (target job) (S102).

Subsequently, the job analysis program 252 refers to the job information management table 800 corresponding to the target job and specifies a file (use file) to be used in the target job (S103). Then, the job analysis program 252 refers to the file virtualization management information 600 and specifies a state and the like of the use file (S104). In the case where the state of the use file is “Stub”, the job analysis program 252 specifies the data size of the use file, total size of the part which is “Stub” in the use file, the referenced site name, and the like, and stores the specified information into corresponding fields in the use data information 830 in the job information management table 800.

Subsequently, the job analysis program 252 determines the part which is in the stub state in the file in the stub state in the use file as data to be migrated before job execution (S105) and advances the process to step S101.

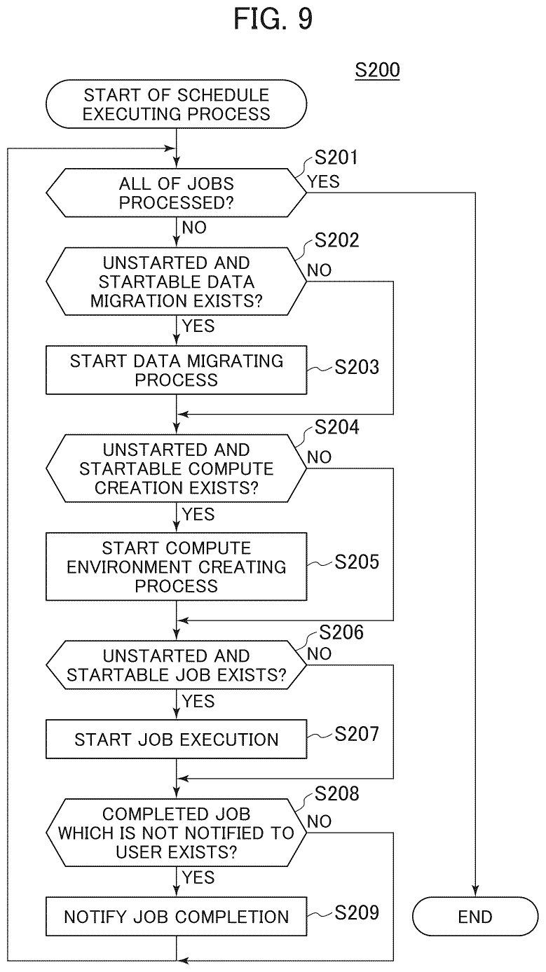

FIG. 9 is a flowchart of a schedule executing process according to the first embodiment.

A schedule executing process (S200) may be executed, for example, on completion of the job analyzing process, on completion of the data migrating process, on completion of the compute environment creating process, or on completion of the job, or may be executed every predetermined cycle.

In the schedule executing process, first, the scheduler program 251 (strictly, the CPU 211 which executes the scheduler program 251) checks whether all of jobs which are set to be executed are processed or not (S201). In the case where all of jobs are processed as a result of the check (YES in S201), the scheduler program 251 finishes the schedule executing process.

On the other hand, in the case where all of jobs are not processed (NO in S201), the scheduler program 251 checks whether or not there is data migration which is unstarted and can be started (S202). The scheduler program 251 determines whether data migration can be started or not on the basis of the use situation of the communication band among sites in which data migration is performed and allocation of a communication band of data migration related to another job.

In the case where there is applicable data migration as a result of the determination (YES in S202), the scheduler program 251 starts a data migrating process of performing the applicable data migration by the migration instruction program 253 (S203), and advances the process to step S204. At this time, the scheduler program 251 changes the data migration situation 879 in the execution time management table 860 to “started”. The migration instruction program 253 may designate the maximum band used for the applicable data migration and perform allocation control on the use band with respect to another data migration. On the other hand, in the case where applicable data migration does not exist (NO in S202), the scheduler program 251 advances the process to step S204.

In step S204, the scheduler program 251 checks whether nor not there is compute environment creation which is unstarted and can be started. In the case where data migration related to the job corresponding to a compute environment to be created has been completed, the scheduler program 251 determines that the compute environment creation can be started.

When there is applicable compute environment creation as a result of the determination (YES in S204), the scheduler program 251 makes the compute environment creation instruction program 254 start a compute environment creating process for performing compute creation corresponding to the compute cluster 30 (S205), and advances the process to step S206. At this time, the scheduler program 251 changes the compute environment creation situation 869 in the execution time management table 860 to “started”. The compute environment creating process may include processes of ensuring a VM for executing the job 390 by the VM execution platform program 351 and creating an environment for executing the job on the assured VM by the compute environment creation program 352. On the other hand, when applicable compute creation does not exist (NO in S204), the scheduler program 251 advances the process to step S206.

In step S206, the scheduler program 251 checks whether or not there is a job which is unstarted and can be started. In the case where both data migration related to a corresponding job and compute environment creation have been completed, the scheduler program 251 determines that execution of the job can be started.

When there is an applicable job as a result (YES in S206), the scheduler program 251 makes the job execution instruction program 255 start executing the applicable job (S207) and advances the process to step S208. On the other hand, when there is no applicable job (NO in S206), the scheduler program 251 advances the process to step S208.

In step S208, the scheduler program 251 checks whether or not there is a job which has been completed and has not been notified to the user.

When there is an applicable job as a result of the check (YES in S208), the scheduler program 251 notifies the user of completion of the applicable job via the host 150 (S209), and advances the process to step S201. On the other hand, when there is no applicable job (NO in S208), the scheduler program 251 advances the process to step S201.

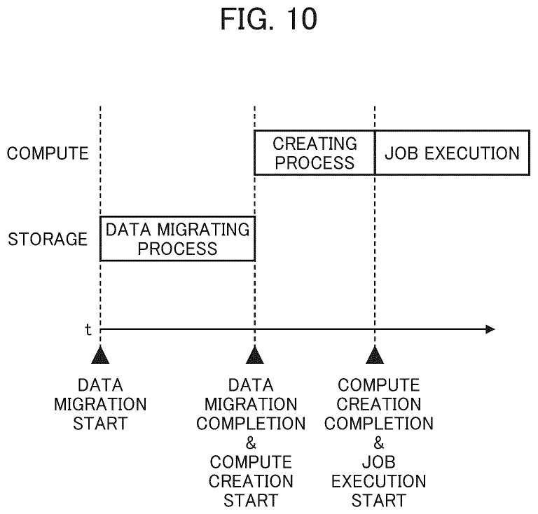

FIG. 10 is a diagram for explaining a schedule of a series of processes related to execution of a job in the first embodiment. FIG. 10 illustrates a schedule of a series of processes related to execution of a certain job.

For a job, first, data which has to be migrated is determined by the job analyzing process (S100). Subsequently, when the schedule executing process (S200) is executed, it is determined that there is data migration which is unstarted and can be started for the job (YES in step S202 in FIG. 9), the data moving process in a storage cluster is started (S203). When the started data migrating process is completed, it is determined that there is compute environment creation which is unstarted and can be started (YES in step S204), and the compute environment creating process is started (S205).

When the compute environment creating process is finished, it is determined that there is a job which is unstarted and can be started (YES in S206), execution of the job is started (S207) and, after that, the job is completed.

By the scheduling according to the first embodiment as described above, the compute environment creation is executed after completion of the data migrating process, and it is unnecessary to wait for completion of the data migrating process in a state where the compute environment creation is completed. Consequently, the state where the created compute environment is ensured in vain can be properly prevented. For example, in the case of creating a compute environment in public cloud, the cost required to use the compute environment in the public cloud can be reduced.

### Second Embodiment

A computer system according to a second embodiment will now be described. In description of the computer system according to the second embodiment, the same reference numeral may be used for a part similar to that in the computer system according to the first embodiment.

The computer system according to the second embodiment is different from the computer system according to the first embodiment with respect to the schedule executing process by the scheduler program 251 and the job analyzing process by the job analysis program 252. The hybrid cloud management node 210 of the computer system according to the second embodiment has a compute environment creation management table 750 in place of the compute environment creation management table 700, and a job information management table 850 in place of the job information management table 800.

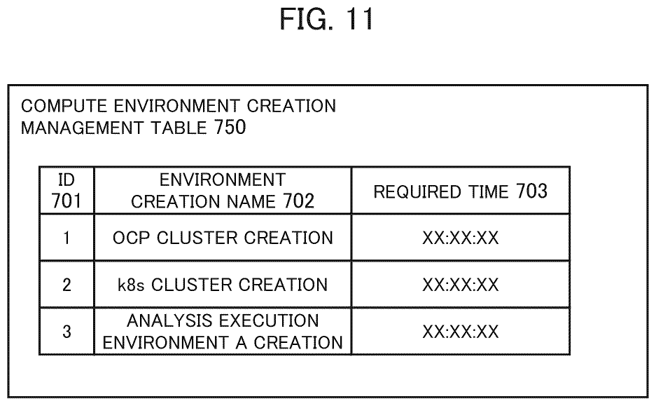

FIG. 11 is a configuration diagram of the compute environment creation management table according to the second embodiment. The same reference numerals are designated to the same fields as those of the compute environment creation management table 700.

The compute environment creation management table 750 includes an entry for each compute environment creation. An entry in the compute environment creation management table 750 includes fields of the ID 701, the environment creation name 702, and required time 703.

In the required time 703, required time of compute environment creation corresponding to the entry is stored. As the required time, for example, time required for similar compute environment creation in the past may be set, or time may be set by the user.

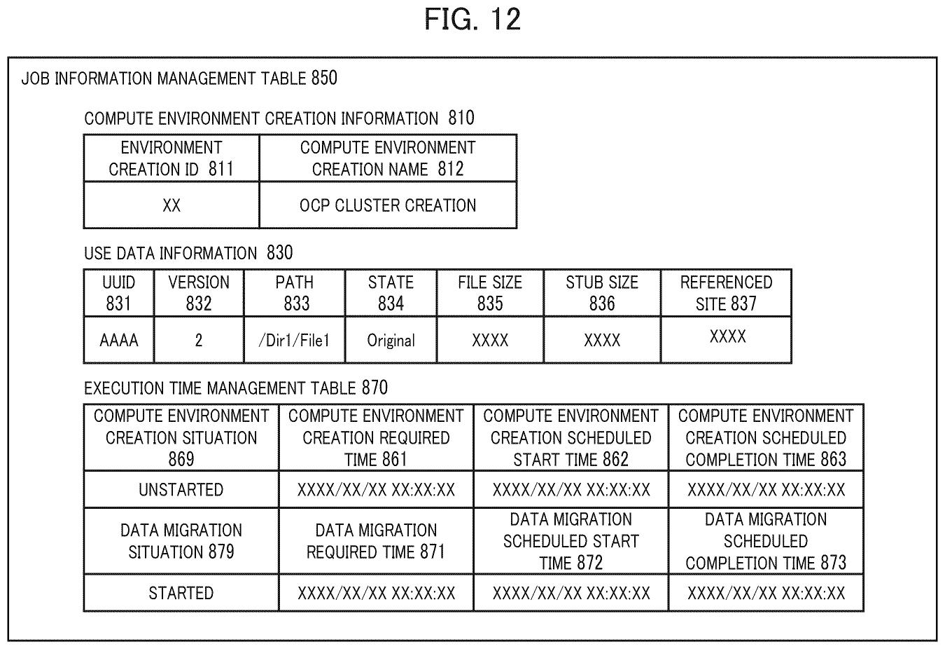

FIG. 12 is a configuration diagram of a job information management table according to the second embodiment. The same reference numerals are designated to the same information and fields as those of the job information management table 800.

The job information management table 850 is generated for each job 390. The job information management table 850 includes the compute environment creation information 810, the use data information 830, and an execution time management table 870.

The execution time management table 870 stores information for managing an execution state of a process related to a corresponding job. The execution time management table 870 includes the fields of the compute environment creation situation 869, compute environment creation required time 861, compute environment creation scheduled start time 862, compute environment creation scheduled completion time 863, the data migration situation 879, data migration required time 871, data migration scheduled start time 872, and data migration scheduled completion time 873.

In the compute environment creation required time 861, a prediction value of required time of a compute environment creating process for executing a corresponding job is stored. In the compute environment creation scheduled start time 862, scheduled time of starting the compute environment creating process (scheduled start time) is stored. In the compute environment creation scheduled completion time 863, scheduled completion time of the compute environment creating process is stored. In the data migration required time 871, a prediction value of required time of a data migrating process is stored. In the data migration scheduled start time 872, scheduled time of starting the data migrating process is stored. In the data migration scheduled completion time 873, scheduled time of completing the data migrating process is stored.

A process operation of the computer system 1 according to the second embodiment will now be described.

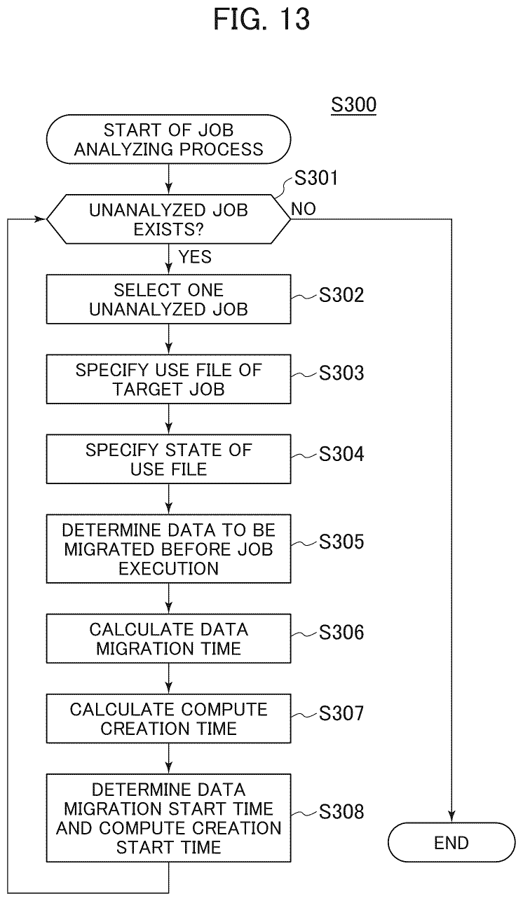

FIG. 13 is a flowchart of a job analyzing process according to the second embodiment.

A job analyzing process (S300) is executed in the case such that, for example, when the job execution request reception program 256 of the hybrid cloud management node 210 receives a job execution request (execution instruction) via a client process by the client program 170 of the host 150.

In the job analyzing process, access data of each job and the content of compute environment creation for executing a job are checked, and data migration of data used by the job, compute environment creation, and a job execution timing are scheduled. In the example of FIG. 13, as data migration to be scheduled, data migration of migrating data which is used by a job and is in a file in a stub state by file virtualization is a target. Alternatively, for example, in data hierarchical control or the like, data migration of migrating data used by a job, which is placed in a remote site or a low-performance storage device before job execution to a local site or a high-performance storage device may be set as a target.

Processes in steps S301 to S305 in the job analyzing process S300 are similar to those in steps S101 to S105 in the job analyzing process S100.

After completion of step S305, the job analysis program 252 (strictly, the CPU 211 executing the job analysis program 252) calculates time (data migration time) required for the data migrating process and stores it in the data migration required time 871 in the job information management table 850 (step S306). For example, the job analysis program 252 calculates the total size of data (migration data) which has to be migrated in use data on the basis of the job information management table 850. Subsequently, the job analysis program 252 estimates data migration time on the basis of a bandwidth (inter-site network throughput) which can be used for data migration between a referenced site and a data migration destination. Concretely, by dividing the total size of migration data by the inter-site network throughput, the data migration time is calculated. The band which can be used for data migration between a referenced site and a data migration destination may be, for example, the maximum band which can be used or a predetermined band.

Subsequently, the job analysis program 252 calculates time required for the compute environment creating process (compute environment creation time), and records it in the compute environment creation required time 861 in the job information management table 850 (step S307). For example, the job analysis program 252 refers to the compute environment creation management table 750 and obtains required time in the field of the required time 703 of the corresponding environment creation.

After that, the job analysis program 252 determines the data migration start time and the compute environment creation start time (S308), and advances the process to step S301. For example, on the basis of the data migration time and the compute environment creation time, the job analysis program 252 determines the start time of the data migrating process and the start time of the compute environment creating process so that the completion time of the data migrating process and that of the compute environment creating process become the same. In this case, for example, either the data migrating process or the compute environment creating process having longer process time is started at predetermined time (present time or designated time), and the start time of the other process may be determined so that the other process is finished at the completion time of the longer process. In the case where the execution start time of a job (job execution start time) is determined in advance, the start time of each of the processes may be determined so that the data migrating process and the compute environment creating process are finished at the job execution start time, and the job execution can be started at the execution start time.

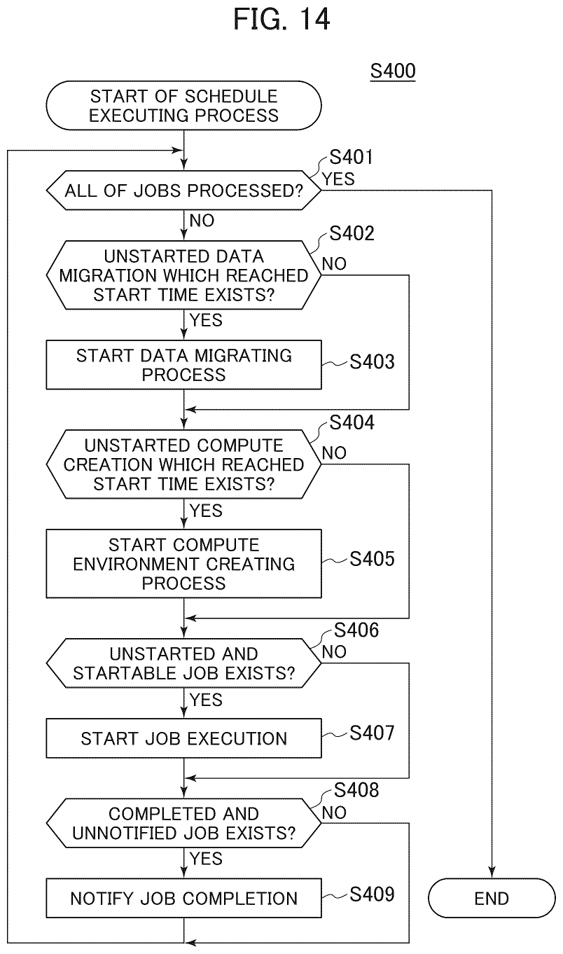

FIG. 14 is a flowchart of a schedule executing process according to the second embodiment.

The schedule executing process (S400) may be executed, for example, on completion of the job analyzing process S300, on completion of the data migrating process, on completion of the compute environment creating process, or on completion of the job, or may be executed every predetermined cycle.

The process in step S401 is similar to the process in step S201 of the job analyzing process S200.

In the case where all of jobs are not processed (NO in S401), the scheduler program 251 checks whether or not there is data migration which is unstarted and reaches the data migration scheduled start time (S402). For example, the scheduler program 251 determines whether or not there is data migration on the basis of the data migration start time of the data migration scheduled start time 872 in the job information management table 850. The data migration start time of a target job may be delayed or another data migration may be interrupted on the basis of a use situation of the communication band between sites in which data migration is performed or an allocation situation of the communication band of data migration related to another job.

When there is data migration which is unstarted and reaches the data migration scheduled start time as a result of the check (YES in S402), the scheduler program 251 executes the process of step S403 and advances the process to step S404. The process of step S403 is similar to that of step S203 in the job analyzing process S200. On the other hand, when there is no data migration which is unstarted and reaches the data migration scheduled start time (NO in S402), the scheduler program 251 advances the process to step S404.

In step S404, the scheduler program 251 checks whether or not there is compute environment creation which is unstarted and reaches the compute creation scheduled start time. For example, the scheduler program 251 determines whether the compute environment creation can be started or not on the basis of the compute environment creation start time of the compute environment creation scheduled start time 862 in the job information management table 850. When there is the compute environment creation which is unstarted and reaches the compute environment creation scheduled start time as a result of the check (YES in S404), the scheduler program 251 executes the process of step S405 and advances the process to step S406. The process of step S405 is similar to that of step S205 in the job analyzing process S200. On the other hand, when there is no compute environment creation which is unstarted and reaches the compute environment creation scheduled start time (NO in S404), the scheduler program 251 advances the process to step S406.

The processes of steps S406 to S409 are similar to the processes of steps S206 to S209 in the job analyzing process S200.

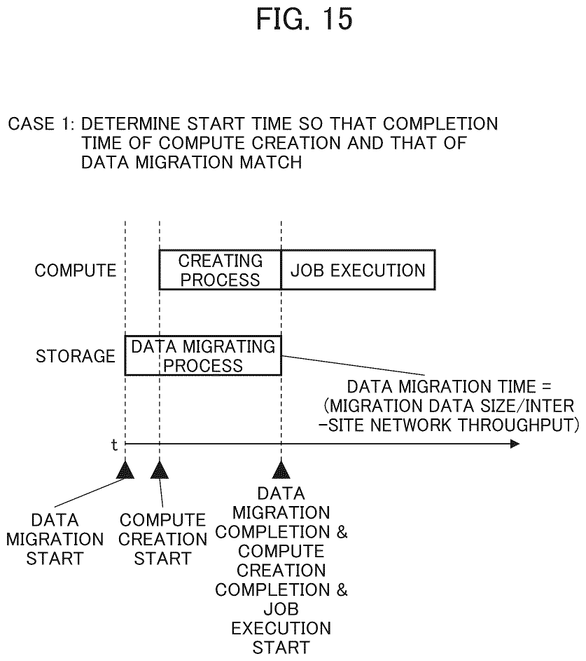

FIG. 15 is a diagram for explaining a first schedule of a series of processes related to execution of a job according to the second embodiment. FIG. 15 illustrates a schedule of a series of processes related to execution of a certain job.

For a job, first, by the job analyzing process (S300), data which has to be migrated is determined, total size of the data which has to be migrated is determined, and on the basis of a communication band between a migrating site and a migration destination site of the data, data migration required time is estimated. Further, compute environment creation time is estimated. Subsequently, based on the data migration required time and the compute environment creation time, data migration start time and compute environment creation start time are determined. In the example of FIG. 15, on the basis of the data migration required time and the compute environment creation time, the data migration start time and the compute environment creation start time are determined so that the completion time of the data migrating process and that of the compute environment creating process become the same. This example is an example of the case where the data migrating process required time is longer than the compute environment creation time. The data migration start time is before the compute environment creation start time. The completion time of the data migrating process and that of the compute environment creating process are not limited to the same time. The data migration start time and the compute environment creation start time may be determined within a predetermined allowable time (for example, within a few minutes).

In this example, when the schedule executing process (S400) is executed, it is determined that there is data migration which is unstarted and reaches the data migration start time for a job (YES in S402 in FIG. 14), and the data migrating process in the storage cluster starts (S403).

During execution of the data migrating process started, when it is determined that there is compute environment creation which is unstarted and reaches the compute environment creation start time (YES in step S404), the compute environment creating process is started (S405).

Subsequently, when the data migrating process and the compute environment creating process are finished at the same time, it is determined that there is a job which is unstarted and can be started (YES in S406), execution of the job is started (S407) and, after that, the job is completed.

In the schedule according to the second embodiment as described above, at least a part of the data migrating process and a part of the compute environment creating process are performed in parallel. It is consequently unnecessary to wait for completion of the data migrating process in a state where the compute environment creation is completed. Consequently, the state where the created compute environment is ensured in vain can be properly prevented. For example, in the case of creating a compute environment in public cloud, the cost required to use the compute environment in the public cloud can be reduced.

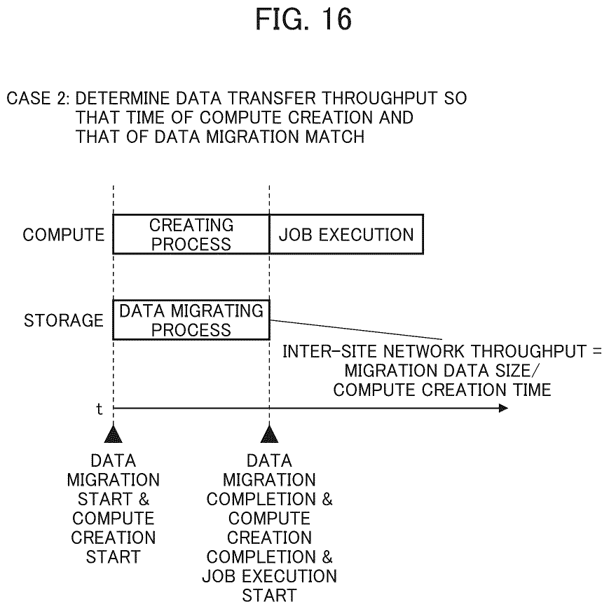

FIG. 16 is a diagram for explaining a second schedule of a series of processes related to execution of a job according to the second embodiment.

For example, in the above-described example, the scheduler program 251 calculates data migration time on assumption of performing data migration by applying a predetermined band (inter-site network throughput) to the data migrating process, and determines a schedule. On the other hand, the scheduler program 251 may change the communication band (inter-site network throughput) in data migration so that the data migration time and the compute environment creation time become the same. Specifically, by dividing the migration data size by the compute environment creation time, the inter-site network throughput may be calculated. In this case, it is the precondition that the inter-site network throughput lies within a realizable range. It is sufficient to determine a schedule by performing the data migrating process at the throughput calculated as described above and setting the data migrating process start time and the compute environment creation start time to the same time. In such a manner, by executing the schedule executing process S400, as illustrated in FIG. 16, the data migrating process and the compute environment creating process start at the same time and end at the same time. After that, execution of a job can be started.

As described above, in the second schedule according to the second embodiment, the data migrating process and the compute environment creating process are performed at least partly in parallel, ideally, performed completely in parallel. Therefore, waiting for completion of the data migrating process in a state where the compute environment creation is completed can be prevented or reduced. Consequently, the state where the created compute environment is ensured in vain can be properly prevented. For example, in the case of creating a compute environment in public cloud, the cost required to use the compute environment in the public cloud can be reduced.

The present invention is not limited to the foregoing embodiments but can be carried out by being properly modified without departing from the gist of the present invention.

For example, in the above-described second embodiment, the scheduler program 251 may calculate the data migration time on assumption that data is migrated by applying a predetermined band to the data migrating process. When the calculated compute environment creation time is longer than the data migration time, the scheduler program 251 adjusts (reduces) the band used for the data migration and, for example, makes the compute environment creation time and the data migration time become the same so that the data migration time lies within the compute environment creation time. In such a manner, the band used for the data migrating process among sites can be suppressed, and the band which can be used by another process can be increased.

What is claimed is:

1. A job execution management system for managing execution of a job in a computer system configured by a plurality of sites,
the system comprising a storage unit and a processor, wherein
the storage unit stores data specifying information which can specify data used in the job, and
the processor determines start time of each process so that at least a part of a data migrating process of migrating data used in a job specified by the data specifying information to a site where the job is executed, and a part of an environment creating process of creating a compute environment for executing the job in the site where the job is executed can be executed in parallel.

2. The job execution management system according to claim 1, wherein
the processor determines start time of the data migrating process and start time of the environment creating process so that end time of the data migrating process and end time of the environment creating process are within predetermined allowable time.

3. The job execution management system according to claim 1, wherein
the processor receives a job execution instruction, specifies data migration time as time required for the data migrating process and environment creation time as time required for the environment creating process, determines end time of the process corresponding to longer one of the data migration time and the environment creation time, and determines start time of the process corresponding to the shorter time on the basis of the end time.

4. The job execution management system according to claim 3, wherein
in the case where the environment creation time is long, the processor determines creation start time at which the environment creating process starts, and determines throughput in the data migrating process so as to be decreased within a range where the data migrating process can be completed by end time of the environment creating process.

5. The job execution management system according to claim 1, wherein
the processor specifies environment creation time as time required for the environment creating process, determines throughput in the data migrating process so that data migration time as time required for the data migrating process lies within the environment creation time, and determines start time so that the data migrating process is completed within the environment creation time.

6. The job execution management system according to claim 1, wherein
the processor
makes the data migrating process and the environment creating process executed, and
after completion of the data migrating process and the environment creating process, starts execution of the job.

7. The job execution management system according to claim 1, wherein
job execution start time as time for starting execution of the job is determined in advance, and
the processor
specifies data migration time as time required for the data migrating process of the job and environment creation time as time required for the environment creating process, and
determines start time of each of the processes so that the data migrating process and the environment creating process are completed by the job execution start time on the basis of the data migration time and the environment creation time.

8. The job execution management system according to claim 7, wherein
the processor decreases throughput in the data migrating process within a range where the data migrating process can be completed by the job execution start time.

9. A job execution management method by a job execution management system for managing execution of a job in a computer system configured by a plurality of sites, wherein
the job execution management system
stores data specifying information which can specify data used in the job, and
determines start time so that at least a part of a data migrating process of migrating data used in a job specified by the data specifying information to a site where the job is executed and a part of an environment creating process of creating a compute environment for executing the job in the site where the job is executed can be executed in parallel.
